(19) United States
(12) Patent Application Publication
(10) Pub. No.: US 2008/0038698 A1
(43) Pub. Date: Feb. 14, 2008

(54) Portable and Visual Cueing System

(75) Inventors: Denise Meissner, College Station, TX (US); Kenith Meissner, College Station, TX (US)

Correspondence Address: Tod T. Tumey, P.O. BOX 22188, HOUSTON, TX, 77227-2188, US

(73) Assignee: QCHARM LLC, Bethesda, MD (US)

(21) Appl. No.: 11/835,317

(22) Filed: Aug. 7, 2007

Related U.S. Application Data
(60) Provisional application No. 60/822,259, filed on Aug. 14, 2006.

(51) Int. Cl. G09B 21/00

(52) U.S. Cl. 434/112

(57) ABSTRACT

A portable visual cueing system and method for providing visual cues are disclosed. In one embodiment, a portable visual cueing system includes a band. The portable visual cueing system further includes a plurality of visual elements attached to the band. Each visual element comprises a display surface and a display disposed on the display surface. In addition, the plurality of visual elements are disposed on the band in an order to provide a desired visual communication.

### CROSS-REFERENCE TO RELATED APPLICATIONS

This application is a non-provisional application that claims the benefit of U.S. Application Ser. No. 60/822,259 filed on Aug. 14, 2006, which is incorporated by reference herein in its entirety.

### STATEMENT REGARDING FEDERALLY SPONSORED RESEARCH OR DEVELOPMENT

Not applicable.

### BACKGROUND OF THE INVENTION

1. Field of the Invention

This invention relates to the field of cueing and more specifically to the field of portable visual cues.

2. Background of the Invention

Visual cues have been developed to provide aid with visual stimulations and reminders for a variety of reasons. Visual cueing systems have typically been used for basic communication, scheduling, reward tracking, and the like for people with emotional, sensory and cognitive issues. For instance, visual schedules have been developed to facilitate communication and transition with autistic children. Such visual schedules typically include a series of visual aids that represent a subject of communication such as daily activities, seasonal changes, and the like. Drawbacks to such conventional visual schedules include that such visual schedules are not sufficiently portable. For instance, such visual schedules are typically disposed on boards or on belts attached to an individual's waist. Further drawbacks to such conventional visual schedules include the visual schedules typically being visually apparent and conspicuous on an individual, which may provide the user with unwanted socially related notice.

Consequently, there is a need for a portable visual cueing system. Further needs include an improved visual cueing system.

### BRIEF SUMMARY OF SOME OF THE PREFERRED EMBODIMENTS

These and other needs in the art are addressed in one embodiment by a portable visual cueing system. The portable visual cueing system includes a band. The portable visual cueing system also includes a plurality of visual elements attached to the band. Each visual element comprises a display surface and a display disposed on the display surface. The plurality of visual elements are disposed on the band in an order to provide a desired visual communication.

In another embodiment, these and other needs in the art are addressed by a portable visual cueing system. The portable visual cueing system includes a band and a display surface. A plurality of displays are stored by the display surface. The display surface displays at least one of the plurality of displays. The portable visual cueing system also includes a control. The control determines which of the plurality of displays is displayed on the display surface.

In other embodiments, these and other needs in the art are addressed by a method for providing visual cues. The method includes providing a band and providing a plurality of visual elements. The method also includes stretching the band to a stretched position. In addition, the method includes attaching at least one of the plurality of visual elements to the band.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a portable visual cueing system comprising a band and visual elements;

FIG. 2 illustrates an embodiment of a portable visual cueing system including a band having openings;

FIG. 3 illustrates a front view of a visual element;

FIG. 4 illustrates various visual displays;

FIG. 5 illustrates a side view of a visual element;

FIG. 6 illustrates a back view of a visual element;

FIG. 7 illustrates a side elevational view of a band that is in an unstretched position;

FIG. 8 illustrates a side elevational view of a band that is in a stretched position;

FIG. 9 illustrates a side elevational view of a band that is in a stretched position with a visual element disposed on the band;

FIG. 10 illustrates a side elevational view of a band in an unstretched position and a visual element disposed on the band;

FIG. 11 illustrates a side view of an embodiment of a visual element with a visual element attachment portion; and

FIG. 12 illustrates a portable visual cueing system comprising a display surface.

### DETAILED DESCRIPTION OF THE PREFERRED EMBODIMENTS

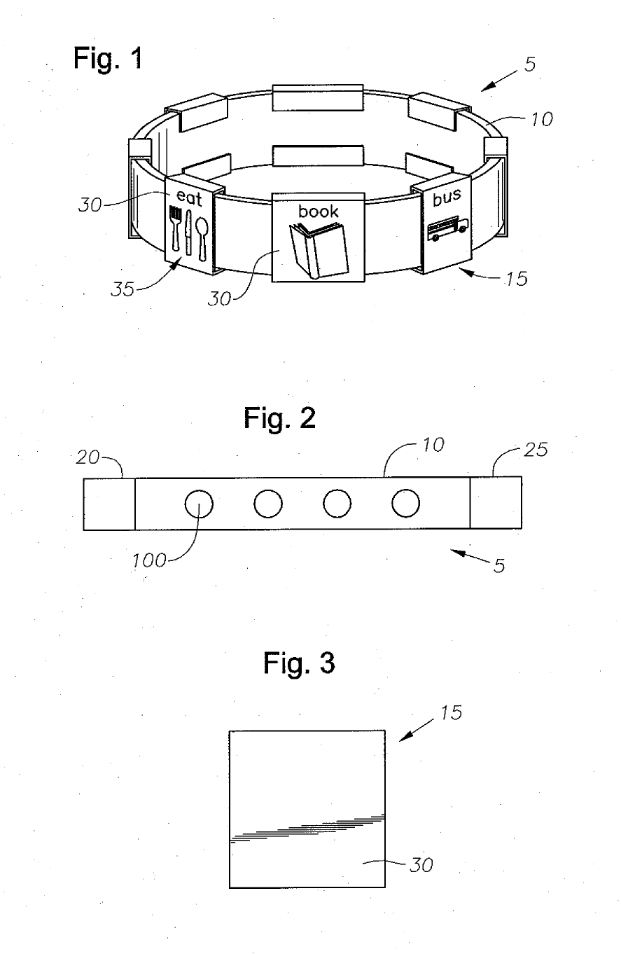

FIG. 1 illustrates an embodiment of portable visual cueing system 5 comprising band 10 and a plurality of visual elements 15. It is to be understood that portable visual cueing system 5 may have any desirable number of visual elements 15. Band 10 may be of any size suitable for use in an embodiment of portable visual cueing system 5. For instance, band 10 may include a size suitable for attachment to the wrist of a person. Band 10 may have any configuration suitable for use with a desired embodiment of portable visual cueing system 5. In an embodiment, band 10 has a configuration suitable for placement on a person's wrist. Examples of suitable configurations include circular configurations or elliptical configurations. Band 10 includes materials that are elastic, non elastic, or any combination thereof. In some embodiments, band 10 includes elastic materials. In other embodiments, portions of band 10 include elastic materials, and portions of band 10 include non elastic materials. In an embodiment in which band 10 includes non elastic materials, the non elastic materials may be pliable materials or substantially rigid materials. In an embodiment, band 10 comprises any elastic materials suitable for use with portable visual cueing system 5. Without limitation, examples of suitable elastic materials include plastic, cotton, rubber, silicone, and the like. In an embodiment, band 10 comprises silicone. Without limitation, examples of suitable non elastic materials include leather, plastic, cotton, rubber, glass, ceramic, wood, metal, and the like. In an alternative embodiment as illustrated in FIG. 2, band 10 is not continuous (as illustrated in FIG. 1) but instead has first end 20 and second end 25. First end 20 and second end 25 may be secured to each other by any suitable means such as by snaps, hooks, and the like. In alternative embodiments (not illustrated), band 10 may be attached to an attaching element such as a key chain. In such an embodiment in which band 10 is attached to a key chain, portable visual cueing system S may be attached to a belt loop or the like.

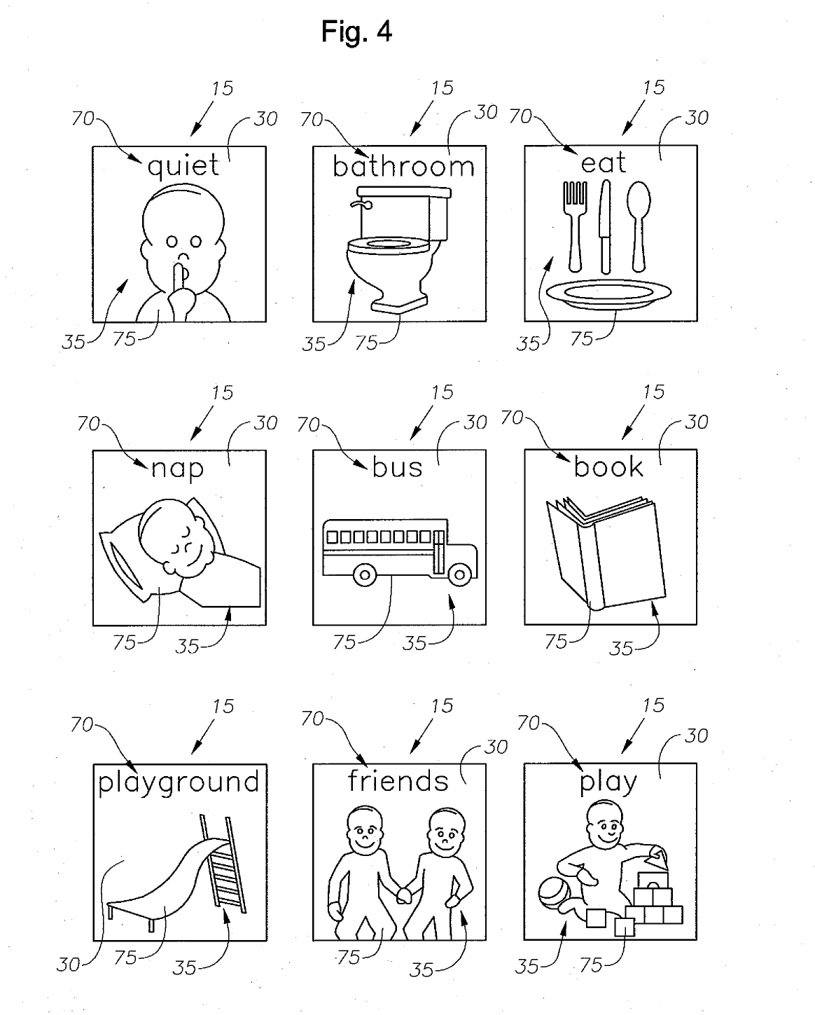

As shown in FIG. 1, visual element 15 includes display surface 30 and display 35. FIG. 3 illustrates a front view of visual element 15. It is to be understood that visual element 15 may have any suitable configuration for use with portable visual cueing system 5. For instance, visual element 15 may have a configuration such as a circular configuration, rectangular configuration, square configuration, and the like. As shown in the embodiment of FIG. 3, the front view of visual element 15 shows a square configuration. Display surface 30 is a suitable surface on which display 35 may be disposed. Display 35 may comprise any symbol suitable for providing a visual communication (e.g., cue) such as a visual stimulation. For instance, display 35 may include symbols, numbers, letters, characters, figures, and the like. Examples of suitable symbols include symbols that relate to actions, activities, seasons, expressions, and the like. FIG. 4 illustrates visual elements 15 with various examples of displays 35. As shown in FIG. 4, examples of displays 35 may include text 70 (e.g., letters, numbers, and/or symbols) that corresponds with a visual image 75. A display 35 may be disposed on a display surface 30 by any suitable means. For instance, a display 35 may be painted, etched, glued, carved, attached by magnetic force, and the like on a display surface 30. As a non limiting example, a display 35 may be a sticker that may be peeled and attached to a display surface 30.

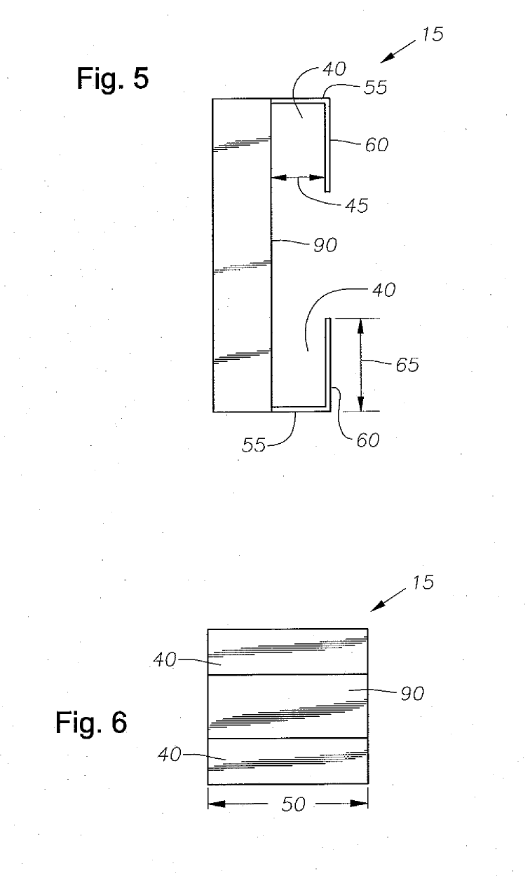

In embodiments, visual element 15 may include any attachment means suitable for attachment to band 10 such as, without limitation, grooves, hooks, suction cups, and/or any other suitable attachment means. In an embodiment, visual elements 15 may be removeably attached to band 10. In alternative embodiments, visual elements 15 are not removeable from band 10 (e.g., secured by glue). FIG. 5 illustrates a side view of an embodiment of visual element 15 in which the attachment means comprises grooves 40. Grooves 40 have a depth 45 suitable for attachment to band 10. Grooves 40 have top portion 55 and backing portion 60. Backing portion 60 has a backing portion length 65 that is a suitable length for substantially preventing unwanted horizontal movement of band 10 (e.g., in embodiments in which visual element 15 is attached to band 10). FIG. 6 illustrates a back view of visual element 15 showing grooves 40 and back side 90 of visual element 15. As shown, a groove 40 has a groove width 50 that is about the same width as the width of visual element 15. In alternative embodiments (not illustrated), at least one or both of grooves 40 have a groove width 50 less than the width of visual element 15. Visual element 15 may have one or more than one groove 40. In an embodiment as illustrated in FIG. 6, visual element 15 has two grooves 40 (e.g., a first groove and a second groove) sufficiently spread apart to allow band 10 between the two grooves 40.

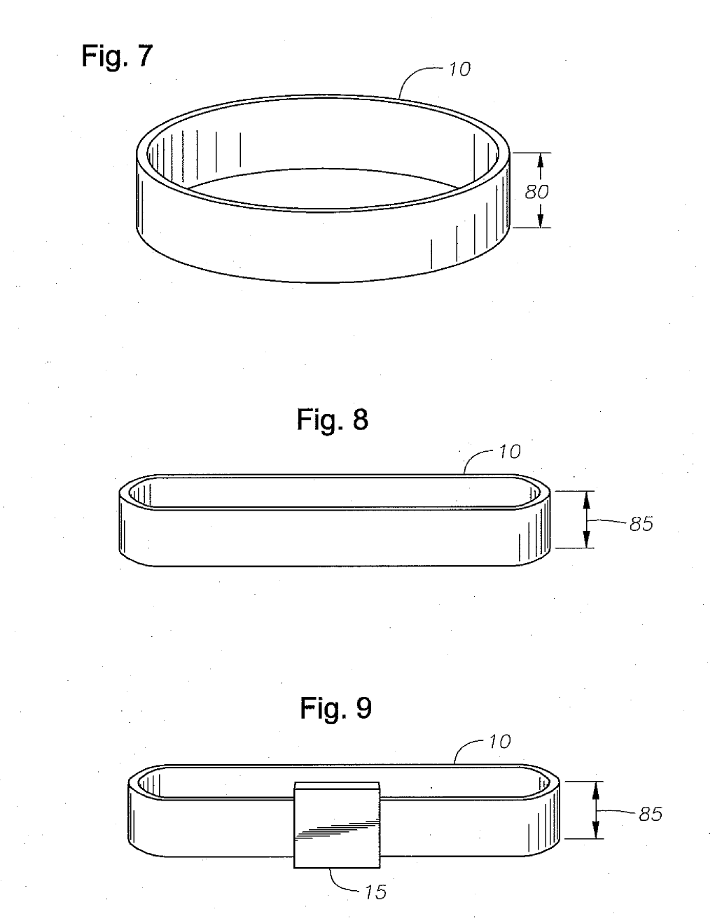

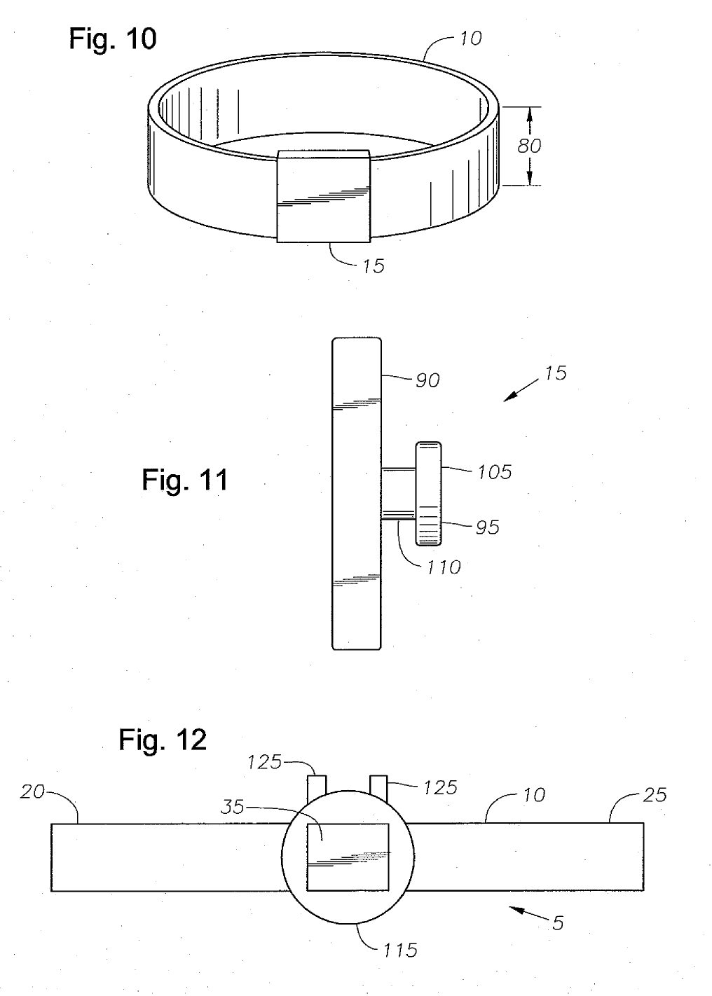

FIGS. 7-10 illustrate an embodiment of a method for attaching visual element 15 to band 10. In such embodiments, band 10 comprises an elastic material that is stretchable upon application of a force and substantially returns to its pre-stretched configuration upon removeable of the force. FIG. 7 illustrates band 10. As shown, band 10 is in an unstretched position. In such an unstretched position, band 10 has unstretched width 80. It is to be understood that unstretched refers to an embodiment in which band 10 has not been substantially lengthened and/or widened. FIG. 8 illustrates band 10 in a stretched position. It is to be understood that stretched refers to an embodiment in which band 10 has been lengthened and/or widened. In such stretched position, band 10 has stretched width 85. Stretched width 85 is less than unstretched width 80. It is to be understood that all or a portion of band 10 may be stretched. As shown in FIG. 9, when band 10 is in such a stretched position, visual element 15 may be positioned on band 10. Visual element 15 may be sufficiently positioned on band 10 whereby a stretched portion of band 10 is disposed between backing portion 60 and back side 90. To sufficiently secure visual element 15 to band 10, the stretching force applied to the stretched portion of band 10 disposed between backing portion 60 and back side 90 may be removed. In some embodiments, substantially all of the stretching force applied to substantially all of band 10 may be removed. The width of band 10 increases and may substantially return to unstretched width 80. Without being limited by theory, the greater width of the unstretched width 80 provides a more secure fit of visual element 15 to band 10. FIG. 10 illustrates an embodiment in which band 10 is in an unstretched position with visual element 15 disposed on band 10. To remove visual element 15 from band 10, band 10 may be stretched to a stretched position, and visual element 15 may be removed. It is also to be understood that visual element 15 may be removed with band 10 in an unstretched position by application of a sufficient force to remove visual element 15.

In an alternative embodiment of attaching visual elements 15 to band 10, visual elements 15 may be secured to band 10 by openings (e.g., holes) in band 10. For instance, as shown in FIG. 2, band 10 includes openings 100. Openings 100 may have any suitable configuration by which a visual element 15 may be attached. In such embodiments, visual elements 15 have an attachment means suitable for attachment to openings 100. In an embodiment, the embodiment of visual element 15 illustrated in FIG. 11 is suitable for attachment to band 10 by openings 100. FIG. 11 illustrates a side view of an embodiment of visual element 15 in which the attachment means includes visual element attachment portion 95. Visual element attachment portion 95 includes attachment end 105 and attachment support 110. Attachment end 105 has a diameter greater than the diameter of opening 100, and attachment support 1 10 has a diameter less than the diameter of opening 100. To attach such an embodiment of visual element 15 to band 10, visual element attachment portion 95 is pressed against opening 100 with sufficient pressure applied to visual element attachment portion 95 for attachment end 105 to pass through opening 100, thereby securing visual element 15 to band 10. To detach visual element 15 from band 10, a suitable force may be applied by which attachment end 105 passes back through opening 100. In such an embodiment, band 10 is comprised of an elastic material.

Visual elements 15 may be displayed in any desirable order. In an embodiment, visual elements 15 are displayed in an order suitable for communication. For instance, as illustrated in FIG. 1, portable visual cueing system 5 has displays 35 that display an order of communication. Without limitation, an example of such an order includes a morning routine. For instance, a first visual element 15 may relate to taking a bath (e.g., show a bath tub or soap bar), a second visual element 15 may relate to putting on clothes (e.g., show clothing), and a third visual element 15 may relate to brushing teeth (e.g., show a tooth brush or a tooth). In some embodiments, one or more visual elements 15 may be disposed on band 10 for different orders (e.g., to signify months, weeks, seasons, and the like). For instance, a visual element 15 may relate to a Christmas tree and be disposed on band 10 for different orders of other visual elements 15 during the month of December.

FIG. 12 illustrates an embodiment of portable visual cueing system 5 in which portable visual cueing system 5 comprises band 10 and display surface 115. Display surface 115 may comprise display 35 and controls 125. Display surface 115 may comprise any suitable display technology such as, without limitation, a liquid crystal display, an organic light-emitting diode, and the like. In such an embodiment, image versions of different types of displays 35 may be stored (e.g., electronically stored) and displayed on display surface 115. Controls 125 may be used to determine which display 35 may be displayed on display surface 115. Portable visual cueing system 5 may have one or more than one control 125. Display surface 115 may illustrate one or more displays 35 at a given time. In some embodiments (not illustrated), display surface 115 may have a split screen (e.g., split into two or more screen visuals) with one or more displays 35 displayed on each screen. In an embodiment, controls 125 may include a back control and a forward control that, when activated, determine whether the order of screens are reversed or forwarded. Display surface 115 may be manufactured with the desired displays 35 and/or the desired displays 35 may be downloaded or transmitted to display surface 115 by any suitable means.

An embodiment illustrating operation of portable visual cueing system 5 as shown in FIG. 12 includes activating a forward control 125 to illustrate a display 35 comprising a blank screen or other desirable display 35 suitable for communicating a non completed task. Upon completion of the desired task (e.g., cleaning a bedroom), the forward control 125 may be activated to show a display 35 representing a completed first task (e.g., a train engine). The forward control 125 may again be activated to show a blank screen display 35. Upon completion of another desired task, the forward control 125 may be activated to show a display 35 representing a completed task and that other tasks are to follow (e.g., a train car). The forward control 125 may again be activated to show a display 35 of a blank screen. Upon completion of another desired task, the forward control 125 may be activated to show a display 35 representing completion of the desired tasks (e.g., a train caboose). Such a representation may represent a reward.

It is to be understood that the portable visual cueing system 5 is not limited to a wrist band design. In alternative embodiments, portable visual cueing system 5 may be of a sufficient size to be disposed in an individual's pocket. For instance, portable visual cueing system 5 may not have a band 10 but instead may comprise display surface 115. Without limitation, an example of a portable visual cueing system 5 for such an embodiment may include a personal digital assistant (PDA).

Without being limited by theory, portable visual cueing system 5 may be suitable for use with any individual having cognitive disabilities. For instance, examples of such disabilities include autism, individuals with Alzheimer's, stroke victims, traumatic brain injury, individuals that have hearing disabilities and are not able to read, and the like.

Although the present invention and its advantages have been described in detail, it should be understood that various changes, substitutions and alterations may be made herein without departing from the spirit and scope of the invention as defined by the appended claims.

What is claimed is:

1. A portable visual cueing system, comprising:
a band; and
a plurality of visual elements attached to the band, wherein each visual element comprises a display surface and a display disposed on the display surface, and wherein the plurality of visual elements are disposed on the band in an order to provide a desired visual communication.

2. The portable visual cueing system of claim 1, wherein the band comprises an elastic material.

3. The portable visual cueing system of claim 2, wherein the band comprises a silicone material.

4. The portable visual cueing system of claim 1, wherein the band comprises a first end and a second end secured to each other.

5. The portable visual cueing system of claim 1, wherein the band is attached to an attaching element.

6. The portable visual cueing system of claim 1, wherein the plurality of visual elements are removeably attached to the band.

7. The portable visual cueing system of claim 1, wherein each of the plurality of visual elements comprises a groove.

8. The portable visual cueing system of claim 7, wherein the groove comprises a top portion and a backing portion, and wherein a portion of the band is disposed between the backing portion and a back side of the visual element.

9. The portable visual cueing system of claim 1, wherein the visual element is removeable from the band when the band is in a stretched position.

10. The portable visual cueing system of claim 1, wherein the band has a stretched width that is less than an unstretched width of the band.

11. The portable visual cueing system of claim 1, wherein the visual element comprises a first groove and a second groove, and wherein the first groove and the second groove are disposed on a back side of the visual element.

12. The portable visual cueing system of claim 1, wherein the band comprises a plurality of openings.

13. The portable visual cueing system of claim 12, wherein each visual element comprises an attachment means comprising an attachment end.

14. The portable visual cueing system of claim 13, wherein the attachment end has a diameter greater than the diameter of the opening.

15. The portable visual cueing system of claim 1, wherein the display comprises a visual image, a text, or both.

16. A portable visual cueing system, comprising:
a band;
a display surface, wherein a plurality of displays are stored by the display surface, and wherein the display surface displays at least one of the plurality of displays; and
a control, wherein the control determines which of the plurality of displays is displayed on the display surface.

17. A method for providing visual cues, comprising:
(A) providing a band;
(B) providing a plurality of visual elements;
(C) stretching the band to a stretched position; and
(D) attaching at least one of the plurality of visual elements to the band.

18. The method of claim 17, further comprising attaching the plurality of visual elements to the band in an order to provide a desired visual communication.

19. The method of claim 17, further comprising (E) providing the band in an unstretched position.

20. The method of claim 17, wherein a groove attaches the at least one of the plurality of visual elements to the band.
